(19) United States
(12) Patent Application Publication
(10) Pub. No.: US 2018/0214946 A1
(43) Pub. Date: Aug. 2, 2018

(54) LAYERWISE MATERIAL APPLICATION METHOD AND APPARATUS FOR ADDITIVE MANUFACTURING

(71) Applicant: GENERAL ELECTRIC COMPANY, Schenectady, NY (US)

(72) Inventor: Thomas Graham SPEARS, Springdale, OH (US)

(21) Appl. No.: 15/423,160

(22) Filed: Feb. 2, 2017

(51) Int. Cl. B22F 3/00; B29C 67/00; B28B 1/00; B33Y 10/00; B33Y 30/00; B33Y 40/00; B23K 26/342; B23K 15/00

(52) U.S. Cl. CPC B22F 3/008; B29C 67/0077; B28B 1/001; B33Y 10/00; B29K 2105/251; B33Y 40/00; B22F 3/003; B23K 26/342; B23K 15/0086; B33Y 30/00

(57) ABSTRACT

In an aspect, the present disclosure relates to an apparatus for fabricating an object layer by layer. The apparatus includes a sheet dispenser to stack sheets of bound powder. The apparatus also includes a directed energy source configured to selectively fuse at least a portion of the bound powder to form one or more fused regions.

### INTRODUCTION

The present disclosure generally relates to additive manufacturing using a laser powder bed process. More specifically, the disclosure relates to providing a layer of powder to the powder bed.

### BACKGROUND

AM processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (DMLS) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of access powder by, for example, blowing or vacuuming. Other post processing procedures include a stress release process. Additionally, thermal and chemical post processing procedures can be used to finish the part 122.

The apparatus 100 is controlled by a computer executing a control program. For example, the apparatus 100 includes a processor (e.g., a microprocessor) executing firmware, an operating system, or other software that provides an interface between the apparatus 100 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly.

Various drawbacks are associated with known recoater mechanisms. For example, as a recoater spreads powder, the recoater or the powder being spread may apply lateral forces to previously built structures, which may result in bending or breaking of such structures. As another example, powder may be spread unevenly or have pockets where the powder has a higher or lower density. Further, powder application may consume a significant amount of time during the build process.

Additionally, there are drawbacks associated with loose powder. Generally, loose powder materials may be relatively difficult to store and transport. There may also be a health risk associated with inhalation of powders. Additional equipment for isolating the powder environment and air filtration may be necessary to reduce these health risks. Moreover, in some situations, loose powder may become flammable.

In view of the foregoing, improvements to an apparatus and methods for adding powder in a powder bed process are desirable.

### SUMMARY

In an aspect, the present invention relates to an apparatus for fabricating an object layer by layer. The apparatus includes a sheet dispenser to stack sheets of bound powder. The apparatus also includes a directed energy source configured to selectively fuse at least a portion of the bound powder to form one or more fused regions.

In another aspect, the present invention relates to a method of fabricating an object layer by layer. The method includes (a) irradiating at least a portion of a given sheet of bound powder with an energy beam to form at least one fused region. The method includes (b) dispensing a subsequent sheet of bound powder over the given sheet. The method includes (c) repeating steps (a) and (b) until the object is formed.

### BRIEF DESCRIPTION OF THE DRAWINGS

FIG. 1 is a schematic diagram showing an example of a conventional apparatus for additive manufacturing.

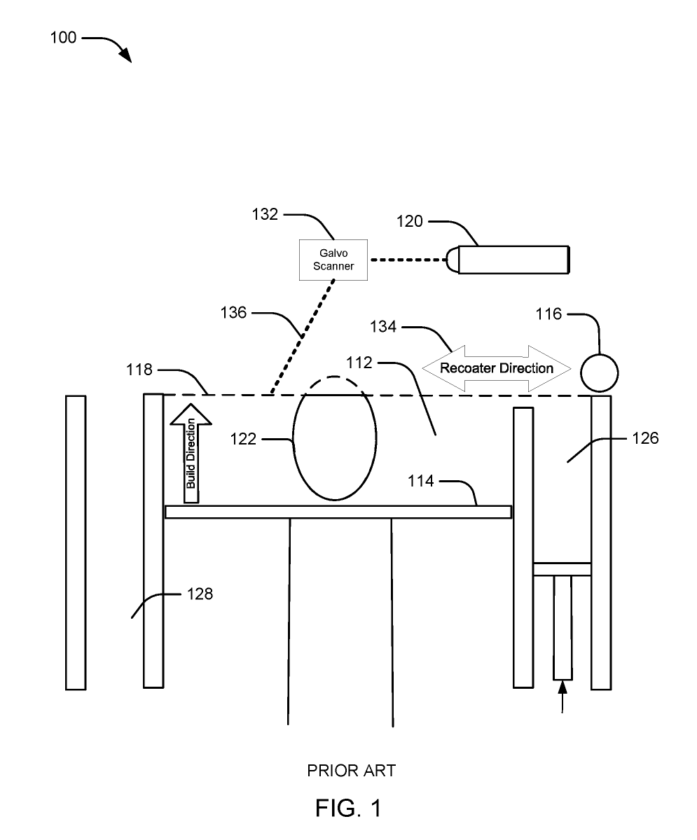

FIG. 2 illustrates a schematic diagram showing a cross-sectional view of an exemplary system for layerwise addition of powder according to an aspect of the disclosure.

FIG. 3 illustrates a schematic diagram showing a cross-sectional view of another exemplary system for layerwise addition of powder according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The present invention improves techniques in the additive manufacturing (AM) process described above. Generally, a freestanding object can be fabricated from a computer aided design (CAD) model. A particular type of AM process uses a directed energy beam, for example, an electron beam or electromagnetic radiation such as a laser beam, to sinter or melt a powder material, creating a solid three-dimensional object in which particles of the powder material are fused together. Different material systems, for example, engineering plastics, thermoplastic elastomers, metals, and ceramics are in use. Either laser sintering or melting are a notable AM processes for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

In an aspect, the present disclosure provides for application of a layer of powder as a bound sheet. The bound sheet may include particles of the powder bound with a polymer or non-polymer binder. In another aspect, the bound sheet may include pre-sintered powder. Similar to the loose powder of conventional techniques, a portion of the powder in the bound sheet is fused with other particles of powder as well as the previous layer using a directed energy beam. For example, the bound particles of powder may be melted or sintered to form a fused region. A subsequent sheet is stacked on top of the recently fused layer. Because the subsequent sheet is provided as a bound sheet, several of the drawbacks of loose powder application are overcome. For example, the bound sheet may have a uniform thickness and density leading to uniform properties of the added layer. As another example, the application of a bound sheet may be faster than application of loose powder. In another example, bound sheets may be provided with predetermined patterns of powder materials within the sheet. Accordingly, use of a bound sheet may provide for use of different materials within a layer of an object. Moreover, the bound sheets of powder may be easier to transport than loose powder. Further, the bound powder sheets may reduce the risk of inhalation or combustion of loose powder.

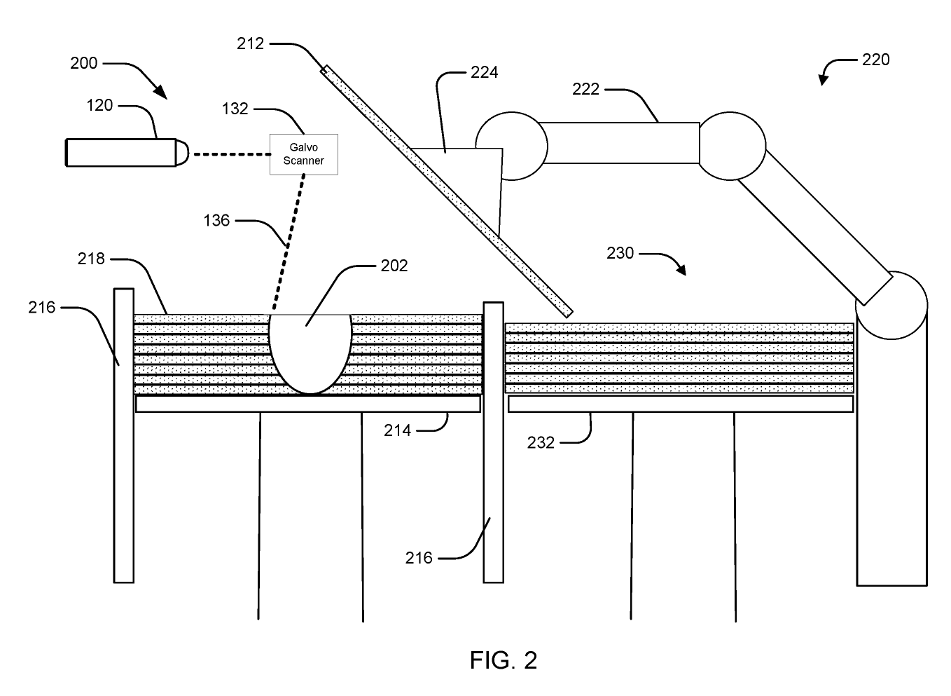

FIG. 2 illustrates a schematic diagram showing a cross-sectional view of an exemplary system 200 for layerwise addition of powder. The system 200 may include several components that are similar to the system 100 such as the directed energy source 120, the galvo scanner 132, and the beam 136. The directed energy source 120 may be, for example, a laser beam or an electron beam. The system 200 also includes a build platform 214. Sheets of bound powder 212 are stacked on the build platform 214 to form a stack 218. In an aspect, the build platform 214 may be surrounded by a bin 216 that defines a build area for the object. The sheets of bound powder 212 may be sized to fit within the bin 216. In another aspect, the sheets 212 may be stacked without a defined bin. A build envelope may be fused within the stack 218 to define a build area for the object and prevent movement between layers. For example, the build envelope may be built as described in U.S. patent application Ser. No. 15/406,467, titled “Additive Manufacturing Using a Mobile Build Volume,” with attorney docket number 037216.00059, and filed Jan. 13, 2017, which is incorporated herein by reference. The build platform 214 may be controlled by a computer (not shown) to raise or lower the stack 218. For example, the build platform 214 may be lowered to bring the most recent sheet of bound powder 212 to a designated height for fusing by the beam 136. However, unlike the system 100, there is no recoater that spreads the powder to a certain level. Instead, because the powder is applied as a bound sheet with a uniform thickness, the stack of sheets has a uniform height.

The system 200 includes a sheet dispenser 220. The sheet dispenser 220 is configured to stack sheets of bound powder on top of the build platform 214. For example, as illustrated in FIG. 2, the sheet dispenser 220 includes a robotic arm 222. The robotic arm 222 may move a sheet of bound powder 212 from a reservoir 230 to the stack 218. The robotic arm 222 may include a mechanism 224 for retaining and releasing a sheet of bound powder 212. For example, the mechanism 224 may include a magnet, suction device, or opposed surfaces that contact the edges of the sheet 212. Accordingly, the robotic arm 222 may pick up a sheet 212 from the reservoir 230 and place the sheet 212 on the stack 218. The reservoir 230 may include a platform 232, which may be controlled by a computer (not shown) to position a sheet 212 for pickup by the robotic arm 222.

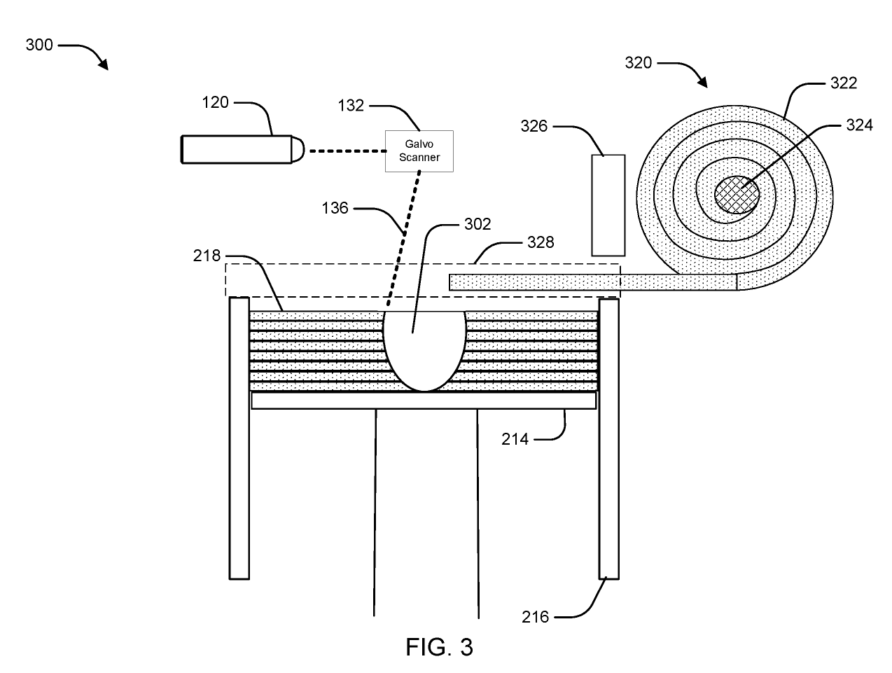

FIG. 3 illustrates a schematic diagram showing a cross-sectional view of another exemplary system 300 for layerwise addition of powder. The system 300 may be similar to the system 200 shown in FIG. 2, except the system 300 includes a different sheet dispenser 320. The sheet dispenser 320 may dispense sheets of bound powder from a continuous roll 322. The continuous roll 322 may be rotatably mounted on a spool 324. A cutter 326 may cut the continuous roll 322 such that the sheet 312 has at least one dimension matching the bin 216. The cutter 326 may be, for example, a blade, a laser cutter, or other known tools for cutting a sheet. The sheet dispenser 320 may further include a conveyor 328 to move the cut sheet from the continuous roll 322 to the top of the stack 218.

A sheet of bound powder may be formed of any powder material used in powder-based additive manufacturing. For example, the powder may include metal, ceramic, or polymer powder. The powder particles may be bound with a polymer or non-polymer binder. In another aspect, the powder particles may be pre-sintered to form a bound sheet. The pre-sintered powder particles may be further fused by selectively melting portions of the sheet with the beam 134.

In an example, a bound metal powder sheet comprises metal powder and a binder. The metal powder may be any metal or metal alloy, such as a metal or metal alloy having a density of 23 g/cm³ to 2 g/cm³, including, but not limited to, as copper, nickel, copper nickel, cobalt, brass, bronze, cadmium, nickel chromium cobalt, nickel chromium, copper zinc, iron nickel, iron, aluminum, titanium, iron-based alloys, nickel-based alloys, cobalt-based, or aluminum-based alloys. The metal alloy powder may be a metal superalloy powder, such as a nickel-chromium superalloy (e.g., Inconel alloy powder, such as Inconel 625 or Inconel 718). The metal powder may be more than 50%, 60%, 65%, 70%, 75%, or 80% of the total volume of the bound metal powder sheet.

The bound sheet includes a binder material, such as monomers and/or oligomers that provide a low viscosity system. For example, the slurry may comprise acrylic based monomers (e.g., 1,6-hexanediol diacrylate), trimethylolpropane triacrylate (TMPTA), diethylene glycol diacrylate, isobornyl acrylate (IBOA), triethylene glycol dimethacrylate (TEGDM), trimethylolpropane propoxylate triacrylate (TMPPTA), diurethane dimethacrylate (DUDMA), acryloyl morpholine (ACMO), ethoxylated (3) trimethylolpropane triacrylate (Sartomer SR454). The liquid monomers and/or oligomers can be made to polymerize and/or crosslink to form a firm, strong gel matrix or “green body”. The gel matrix immobilizes the metal powder into the sheet form. The resultant “green” product exhibits sufficient strength and toughness (i.e., is not brittle, resists tearing, cracking, etc.) for handling. In another example, a sheet of bound ceramic powder may be formed using similar binders.

In an aspect, the sheet of bound powder may include a plurality of fusable materials that are distributed throughout the sheet. For example, the powder sheet may include a mixture of metallic powders that form an alloy when melted. In another aspect, a plurality of materials may be strategically placed within the sheet. For example, a bound powder sheet may have a first region formed of a first fusable material and a second region formed of a second fusable material. The different fusable materials may be retained in their respective regions by the binder such that the regions do not move during placement within the bin 216. Accordingly, the use of the bound powder sheet may allow formation of an object having components of different materials. For example, a first component may be a metal component formed from a region of bound metal powder (e.g., cobalt chrome) and a second component may be a ceramic component formed from a region of bound ceramic powder or a metal component formed from a different bound metal powder (e.g., Inconel 718). The bound powder sheet may have a packing fraction that is selectable using either a single particle size distribution or a plurality of particle size distributions. Generally, the density of the bound powder sheet is less than the density of a solid sheet. That is, the density of the fused material is greater than the density of the bound powder sheet. Control of the deposited powder density increases process stability and leads to better surface roughness. This either eliminates post processing to reach desired levels of surface roughness or opens new operating space for a part that may be heated and exhibit coking as surface roughness is a driver of coking.

In an aspect, the bound powder sheets are each formed in the shape of the bin 216. For example, the reservoir 230 may include a plurality of sheets, each sheet having the same dimensions as the bin 216. Accordingly, the sheets may be uniformly stacked. The shape of the object 202 may be formed by the selection of the regions to be fused by the directed energy source 120. In another aspect, the bound powder sheets may be shaped in the cross section of the layer to be formed. For example, a perimeter of the sheet may correspond to a perimeter of the layer to be formed. The robotic arm 222 may position the shaped sheet of powder in the correct location. Accordingly, the amount of powder may be reduced and post-processing to remove unfused powder may be reduced.

In an aspect, the sheet dispenser 220 or 320 may stack a subsequent sheet of bound powder over a given sheet of bound powder. A given sheet of bound powder may be any previously placed sheet of bound powder. For example, the given sheet of bound powder may be a first sheet of bound powder, or a subsequent sheet of bound powder that has been stacked. In some aspects, the sheet dispenser 220 or 320 may be used with a convention powder distribution mechanism such as the recoater 116. For example, the recoater 116 may be used in addition to the sheet dispenser 220 or 320 to apply a layer of loose powder over a sheet of bound powder. The recoater 116 applies the loose powder after a portion of the sheet of bound powder has been fused. The loose powder ensures that the sheets of bound powder remain level. Accordingly, the stack 218 may include alternating layers of sheets of bound powder and layers of loose powder.

In the disclosed embodiments, the shape of the object 202/302 is defined by selectively fusing regions of the bound powder using the directed energy source. The selective fusing, either sintering or melting, debinds the binder in the fused region. A person of skill in the art will appreciate that the debinding and sintering temperatures depend on the materials (e.g., metal, binder) used. In one aspect, the debinding occurs at a temperature range of 100-600° C., 300-600° C., or 400-500° C. In another aspect, the fusing by sintering occurs at a temperature of 1000-1300° C. Accordingly, fusing portions of the bound powder sheet may concurrently debind the binder

In an aspect, the unfused regions of bound powder are removed using a post-processing operation. For example, the binder may be dissolved or leached from the unfused regions, allowing the powder to be removed. A further post-processing operation may then be used to obtain desired properties of the object. For example, the object may be heated to a high temperature to achieve desired metallurgical or ceramic properties. Post-processing may be conducted using a suitable technique, such as, for example, extrusion, hot isostatic processing (HIP), heat treatment, and the like.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. An apparatus for fabricating an object layer by layer, comprising:
a sheet dispenser to stack sheets of bound powder; and
a directed energy source configured to selectively fuse at least a portion of the bound powder to form one or more fused regions.

2. The apparatus of claim 1, wherein the sheets of bound powder comprise at least one of: metal powder, ceramic powder, or polymer powder.

3. The apparatus of claim 1, further comprising a reservoir to supply the sheet dispenser with the sheets of bound powder.

4. The apparatus of claim 2, wherein the reservoir includes a continuous roll of bound powder and the sheet dispenser cuts the sheets of bound powder from the continuous roll.

5. The apparatus of claim 2, wherein the reservoir includes a plurality of stacked sheets of bound powder.

6. The apparatus of claim 5, wherein the sheet dispenser comprises a robotic arm.

7. The apparatus of claim 1, wherein the sheets of bound powder comprise a mixture of fusable materials distributed throughout each sheet.

8. The apparatus of claim 1, wherein at least one of the sheets of bound powder comprises at least one first region comprising a first fusable material and at least one second region comprising a second fusable material that is different than the first fusable material.

9. The apparatus of claim 8, wherein the first region and the second region correspond to different portions of the object formed of the first fusable material and the second fusable material, respectively.

10. The apparatus of claim 1, wherein the sheet of bound powder is less dense than the fused region.

11. The apparatus of claim 1, wherein the bound powder is bound with a polymer binder.

12. The apparatus of claim 1, wherein the bound powder is bound with a non-polymeric binder.

13. The apparatus of claim 1, wherein the bound powder is bound by sintering prior to stacking.

14. The apparatus of claim 1, wherein the directed energy source fuses the bound powder by selectively melting the bound powder.

15. The apparatus of claim 1, wherein the at least one sheet of bound powder has at least one dimension corresponding to an inner dimension of a powder bed.

16. A method of fabricating an object, comprising:
(a) irradiating at least a portion of a given sheet of bound powder with an energy beam to form at least one fused region;
(b) dispensing a subsequent sheet of bound powder over the given sheet; and
(c) repeating steps (a) and (b) until the object is formed.

17. The method of claim 16, wherein the irradiating comprises melting the bound powder.

18. The method of claim 16, wherein the given sheet of bound powder comprises at least one of: metal powder, ceramic powder, or polymer powder.

19. The method of claim 16, further comprising cutting a continuous roll of bound powder to form the subsequent sheet.

20. The method of claim 16, wherein the stacking comprises removing the subsequent sheet from a reservoir and placing the subsequent sheet over the given sheet.

21. The method of claim 16, wherein the subsequent sheet of bound powder comprises a mixture of fusable materials distributed throughout each sheet.

22. The method of claim 16, wherein the subsequent sheet of bound powder comprises at least one first region comprising a first fusable material and at least one second region comprising a second fusable material that is different than the first fusable material.

23. The method of claim 22, wherein the first region and the second region correspond to different portions of the object formed of the first fusable material and the second fusable material, respectively.

24. The method of claim 16, wherein the sheet of bound powder is less dense than the fused region.

25. The method of claim 16, wherein the bound powder is bound with a polymer binder.

26. The method of claim 16, wherein the bound powder is bound with a non-polymeric binder.

27. The method of claim 16, wherein the bound powder is bound by sintering prior to the stacking.

28. The method of claim 16, wherein the irradiating comprises sintering the bound powder.
